(19) United States
(12) Patent Application Publication
(10) Pub. No.: US 2015/0058150 A1
(43) Pub. Date: Feb. 26, 2015

(54) SYSTEMS AND METHODS FOR PROVIDING SELLING ASSISTANCE

(71) Applicants: Ron Gura, Tel Aviv (IL); Matanya Bar, Tel Aviv (IL); Erez Dickman, Tel Aviv (IL)

(72) Inventors: Ron Gura, Tel Aviv (IL); Matanya Bar, Tel Aviv (IL); Erez Dickman, Tel Aviv (IL)

(21) Appl. No.: 14/183,307

(22) Filed: Feb. 18, 2014

Related U.S. Application Data
(60) Provisional application No. 61/868,449, filed on Aug. 21, 2013.

(51) Int. Cl. G06Q 30/06; G06Q 30/08

(52) U.S. Cl. CPC G06Q 30/0601; G06Q 30/08
USPC 705/26.3

(57) ABSTRACT

Systems and methods are disclosed which assist a user in selling one or more items. The systems and methods may allow a user to provide pictures and a voice description of the items for an expert analysis which may determine an estimated value of the items for the user. The user may then select whether they want to sell the items based on the estimated value, and select options for selling the items which include ordering a pre-labeled package, scheduling a pickup of the items, and finding a local drop-off point for the items. The provided systems and methods make the selling process easier for a user and may convince users who may normally not be inclined to sell items due to the hassle of selling.

### CROSS REFERENCE TO RELATED APPLICATIONS

Pursuant to 35 U.S.C. §119(e), this application claims priority to the filing date of U.S. Provisional Patent Application No. 61/868,449, filed on Aug. 21, 2013, the disclosure of which is hereby incorporated by reference in its entirety.

### BACKGROUND

1. Technical Field

Embodiments disclosed herein are related to systems and methods for providing selling assistance to would-be sellers.

2. Related Art

The internet has connected sellers and buyers from across the globe using online marketplaces such as provided by eBay Inc. of San Jose, Calif. Instead of selling used items at garage sales and the like, sellers may be able to use online marketplaces such as eBay Inc. to sell these items and increase the number of potential buyers. Many sellers are very familiar with the process of online selling. However, some would-be sellers may be uncomfortable attempting to sell items online, as they may not have the time, may not know how much an item is worth, and may not know how best to provide a sold item to a buyer. As a result, some of these would-be sellers do not sell their items.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 illustrates an interface for capturing images of items for selling, consistent with some embodiments.

FIG. 4 illustrates an interface for providing a voice description of items for sale, consistent with some embodiments.

FIG. 5 illustrates an interface for reviewing an estimated value of items for sale, consistent with some embodiments.

FIG. 6 illustrates an interface for selecting selling options, consistent with some embodiments.

FIG. 7 illustrates an interface for scheduling a pickup, consistent with some embodiments.

FIG. 8 illustrates an interface for reviewing selling activity, consistent with some embodiments.

FIG. 9 is a flowchart illustrating a process for selling one or more items using a selling application.

FIG. 10 is a flowchart illustrating a process for assisting user in selling one or more items.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

There is a need for making the selling process easier and more approachable for would-be sellers.

Consistent with some embodiments, there is provided a system for selling one or more items. The system includes an imaging component configured to capture one or more images of the items and a microphone configured to detect a voice description of the items and produce and electric signal corresponding to the detected voice description. The system also includes a memory configured to store the captured one or more images and the electric signal and a network interface component configured to send the captured one or more images and the recoded voice description to a server for processing. The system further includes one or more processors configured to process the estimated value of the items when received from the server and render the estimated value of the items for display and render selling options when a user decides to sell the items. The system also includes a display component configured to display the rendered estimated value of the items and the rendered selling options when a user decides to sell the items, and a bus coupling the imaging component, the microphone, the memory, the network interface component and the one or more processors.

Consistent with some embodiments, there is also provided a method for assisting a user in selling one or more items. The method includes steps of capturing one or more images of the items, recording a voice description of the items, sending the captured one or more images and the recorded voice description, receiving and displaying an estimated value of the items, the estimated value based on an analysis of the captured one or more images and the recorded voice description, and displaying selling options when a user decides to sell the items. The method may be embodied in non-transitory computer-readable media.

Consistent with some embodiments, there is further provided a method for assisting a user in selling one or more items. The method includes receiving at least one or more captured images and a voice description of the items, determining an estimated value of the items, sending the estimated value, receiving selling options, sending a pre-labeled package to the user when a package order selling option is received, and scheduling a pickup of the items when a pickup selling option is received. The method may be embodied in computer-readable media.

Embodiments consistent with this disclosure may provide a would-be seller with an estimated value of items for sale along with options for scheduling a pickup of the items, ordering a pre-labeled package for the items, or finding a drop-off location for the items to make the selling process much easier for the seller.

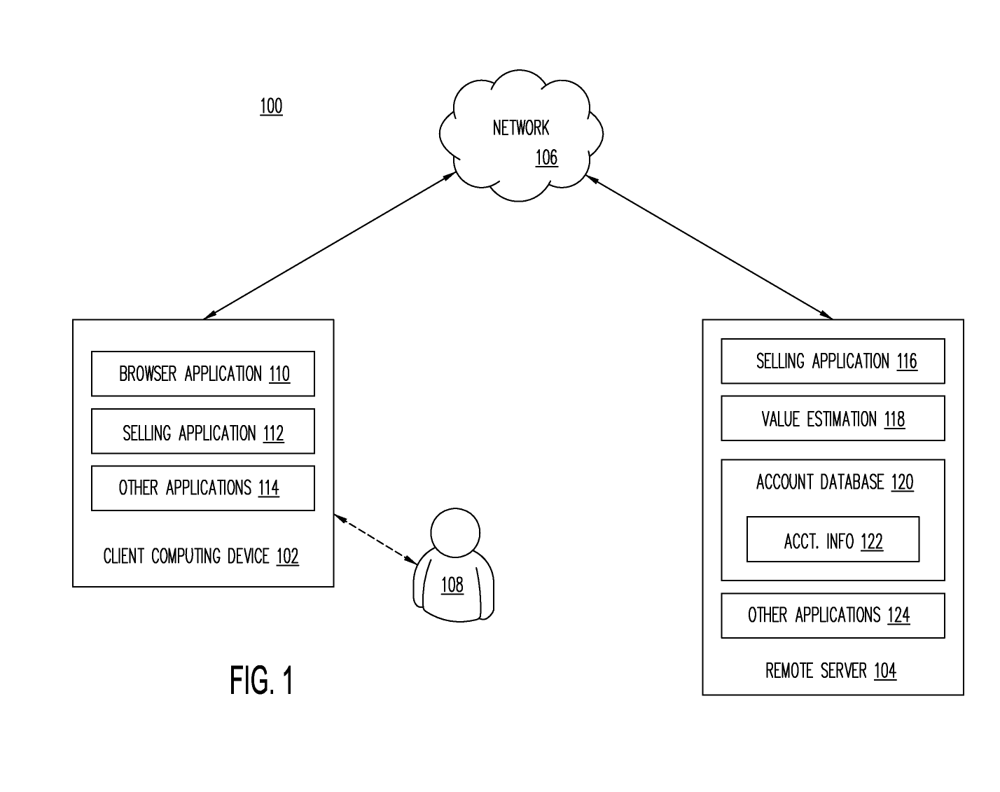

FIG. 1 is a block diagram of a networked system 100, consistent with some embodiments. System 100 includes a client computing device 102 and a remote server 104 in communication over a network 106. Remote server 104 may be a hosting server that hosts webpages and other online content accessible by user 108 using client computing device 102 over network 106. In some embodiments, remote server 104 may correspond to an online marketplace server where users such as user 108 can buy and sell goods and items (collectively referred to as “items”), such as may be provided by eBay Inc. of San Jose, Calif. Remote server 104 may be maintained by other service providers in different embodiments. In some embodiments, remote server 104 may correspond to a payment service processing server and also host merchant-specific content. Moreover, remote server 104 may correspond to one or more servers in some embodiments.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client computing device 102, in one embodiment, may be implemented using any appropriate combination of hardware and/or software configured for wired and/or wireless communication over network 106. For example, client computing device 102 may be implemented as a wireless telephone (e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

Client computing device 102 may include any appropriate combination of hardware and/or software having one or more processors and capable of reading instructions stored on a tangible non-transitory machine-readable medium for execution by the one or more processors. Consistent with some embodiments, client computing device 102 includes a machine-readable medium, such as a memory (not shown) that includes instructions for execution by one or more processors (not shown) for causing client computing device 102 to perform specific tasks. In some embodiments, the instructions may be executed by the one or more processors in response to interaction by a user 108. For example, such instructions may include a browser application 110 such as a mobile browser application, which may be used to provide a user interface to permit user 108 to browse information available over network 106, including information hosted by remote server 104. For example, browser application 110 may be implemented as a web browser to view information available over network 106. Browser application 110 may include a graphical user interface (GUI) that is configured to allow user 108 to interface and communicate with remote server 104 or other servers managed by content providers or merchants via network 106. For example, user 108 may be able to access websites to find and purchase items, as well as access user account information or web content.

Client computing device 102 may also include a selling application 112. In some embodiments, selling application 112 may provide functionalities to allow user 108 to sell one or more items on an online marketplace such as may be provided by remote server 104. The functionalities provided by selling application 112 may include allowing user 108 to take pictures or capture images of the items that user 108 wants to sell, allow user 108 to provide a written and/or verbal description of the items that user 108 wants to sell, get an estimate of the value of the items based on the pictures and description, and provide user 108 with options for selling. In some embodiments, the options for selling may include scheduling a pickup for the items, finding a drop-off location at which user 108 can drop off the items, ordering a pre-sized package that will be shipped to user 108 for shipping the items to a location where the items will be prepared for selling on the online marketplace provided by remote server 104, or just allowing user 108 to ship the items to the location. Selling application 112 may also provide additional information, such as the activity surrounding the items for sale.

Client computing device 102 may further include other applications 114 as may be desired in one or more embodiments to provide additional features available to user 108, including accessing a user account with remote server 104. For example, applications 114 may include interfaces and communication protocols that allow the user to receive and transmit information through network 106 and to remote server 104 and other online sites. Applications 114 may also include security applications for implementing client-side security features, programmatic client applications for interfacing with appropriate APIs over network 106 or various other types of generally known programs and/or applications.

Remote server 104 may be maintained by a provider providing an online marketplace, such as eBay Inc. of San Jose, Calif. Remote server 104 may include a selling application 116 which may be capable of interfacing with selling application 112 of client computing device 102. In some embodiments, selling application 116 may facilitate scheduling a pickup for the items that are being sold by user 108, providing drop-off locations at which user 108 can drop off the items, and facilitating ordering a pre-sized package that will be shipped to user 108 for shipping the items to a location where the items will be prepared for selling.

Remote server 104 may also include value estimation functionality 118. In some embodiments, value estimation 118 may include a program or application that automatically estimates a value for the items being sold by user 108 based on the pictures and description sent to remote server 104 by selling application 112 of client computing device 102. In some embodiments, value estimation 118 may include an interface from which experts can review the provided pictures and verbal and/or written description and provide an estimate of the value of the items based on the pictures and description. Value estimation 118 may provide the estimated value to selling application 116 which may then provide the estimated value to selling application 112 over network 106. Remote server 104 may further include an account database 120 that includes account information 122 for users having an account on remote server 104, such as user 108. Account information 122 in account database 120 may also include the locations of merchants, and drop-off locations. Remote server 104 may include other applications 124 providing other functionalities.

Although discussion has been made of applications and applications on client computing device 102 and remote server 104, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications.

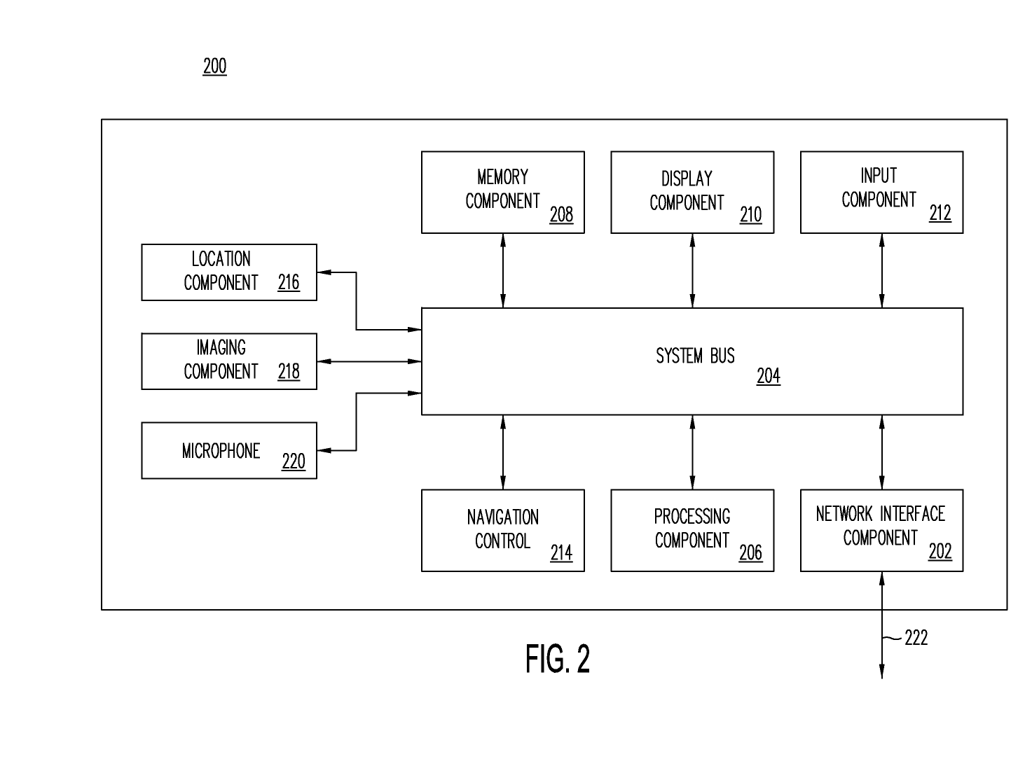

FIG. 2 is a diagram illustrating computing system 200, which may correspond to either of client computing device 102 or remote server 104, consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with client computing device 102. Further, computing system 200 may also be a server or one server amongst a plurality of servers, as would be consistent with remote server 104. As shown in FIG. 2, computing system 200 includes a network interface component (NIC) 202 configured for communication with a network such as network 106 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 106. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs). Computing system 200 may also include a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 108 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. In some embodiments, processing component may be configured to render information for display by display component 210. The rendered information may include a user interface, graphics, and the like. In some embodiments, the rendered information may be rendered based on instructions included in selling application 112, and may include selling options. Computing system 200 may also include an input component 212, allowing for a user of computing system 200, such as user 108, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if computing system 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include am imaging component 218. In some embodiments, imaging component 218 may be an optical camera capable of capturing images. In some embodiments, the captured images may be a series of captured images, such as video frames. Imaging component 218 may be used by selling application 114 of client computing device 102 to capture images of items that user 108 wants to sell.

Computing system 200 may further include a microphone 220 for detecting and receiving audio input from, for example, user 108. According to some embodiments, microphone 220 may be configured to detect audio, such as a voice, which is then transmitted to processing component 206 for processing and to memory component 208 for storage. In some embodiments, microphone 220 may be configured for detecting a voice from user 108 for use in providing a verbal description of items that user 108 is selling. Microphone 220 may be integrated with computing system 200 or may be separate and coupled to computing system 200 by a cable or wireless coupling. According to some embodiments, microphone 220 detects audio waveforms associated with a voice of user 108, and translates the detected waveforms into one or more electrical signals that are transmitted to processing component 206 for processing according to instructions stored in memory component 208.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 106 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

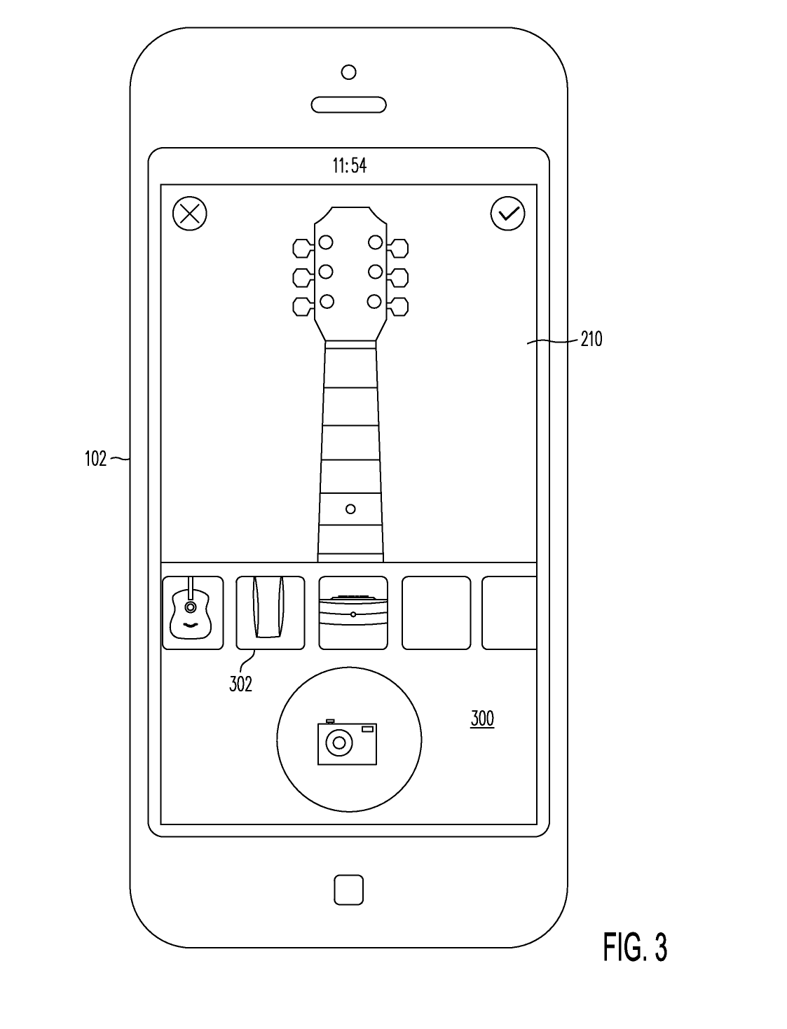

FIG. 3 illustrates an interface 300 for capturing images of items for selling, consistent with some embodiments. As shown in FIG. 3, selling application 112 may provide an interface 300 to be displayed on display component 210 of client computing device 102 for taking pictures of items for selling. Interface 300 may provide user 108 with the ability to capture one or more images of an item that user 108 wishes to sell using imaging component 218. Interface 300 may also allow user 108 to review the captured images, delete captured images, store the captured images, and send the captured images to remote server 104. In some embodiments, user 108 may capture an image of an item for sale using imaging component 218, which will be stored in memory component 208 of client computing device 102 as part of a data file that, along with a written or verbal description of the item shown in the captured image, will be sent to remote server 104 for value estimation by value estimation application 118. Stored captured images may be displayed in an image roll 302. User 108 may be able to select different images from image roll 302, which may then be displayed in interface 300 for viewing by user 108. In some embodiments, the different image roll 302 may correspond to different views of a single item, or may correspond to different items that user 108 is interested in selling.

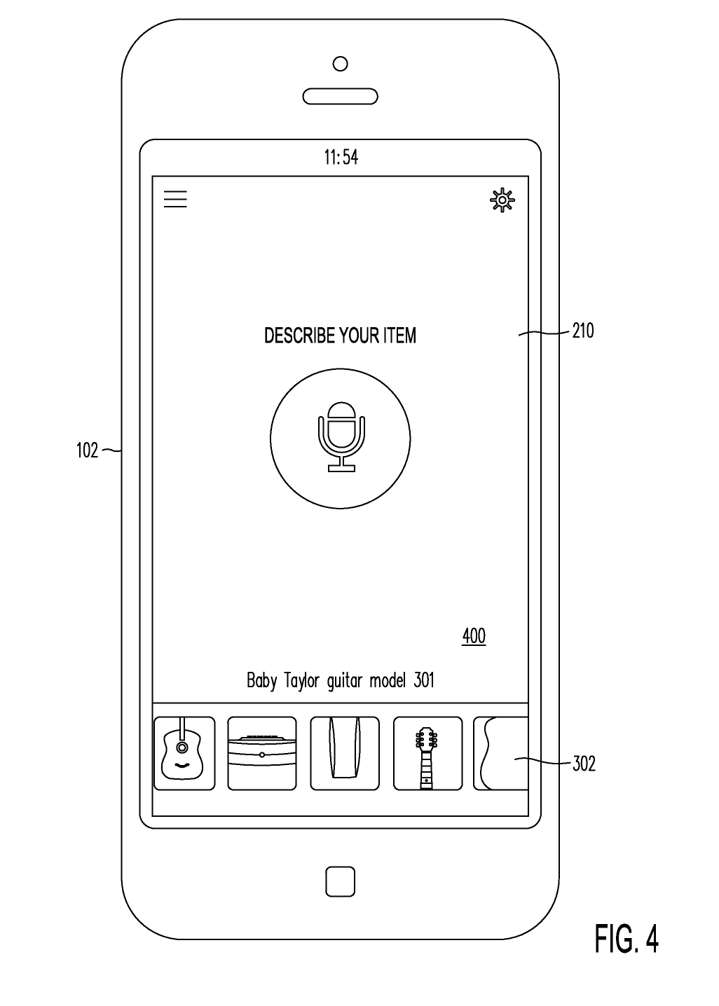

FIG. 4 illustrates an interface 400 for providing a voice description of items for sale, consistent with some embodiments. As shown in FIG. 4, selling application 112 may provide an interface 400 to be displayed on display component 210 of client computing device 102 for use by user 108 in providing a voice description of items for sale. Interface 400 may provide user 108 with the ability to record a description of an item that user 108 wishes to sell using microphone 220. In some embodiments, selling application 112 may be capable of converting the captured voice description into text, which may be displayed in interface 400 and sent to remote server 104. Moreover, image roll 302 may be displayed in interface 400 so that user 108 can select different images in in image roll 302 to provide a voice description for each image.

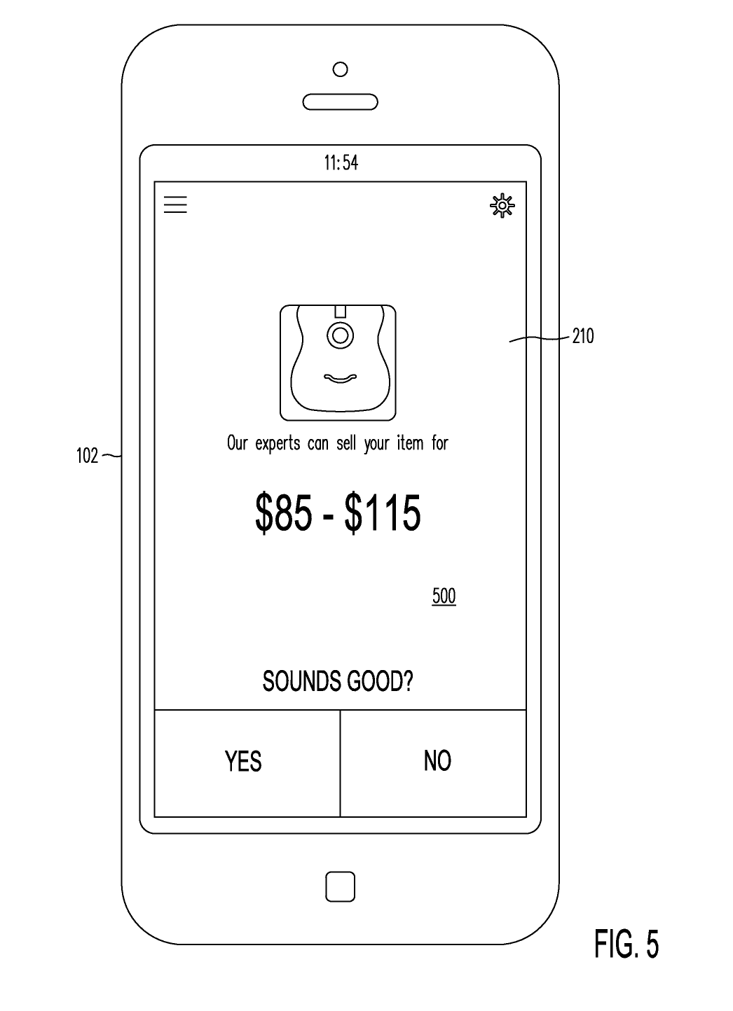

FIG. 5 illustrates an interface 500 for reviewing an estimated value of items for sale, consistent with some embodiments. As shown in FIG. 5, selling application 112 may provide interface 500 to be displayed on display component 210 of client computing device 102 for user 108 to review the estimated value of the items for sale, based on an estimated value provided by value estimation 118 of remote server 104. Interface 500 may allow user 108 to make an informed decision as to whether they want to proceed to sell the items based on the provided value estimate.

In some embodiments, after user 108 captures one or more images of an item or items that user 108 may be interested in selling, and provides a voice or written description, selling application 112 may include instructions that, when executed by processing component 206 of client computing device 102, causes processing component 206 to send one or more data files including the images and description over network using network interface component 202 to remote server 104. Remote server 104 may receive the one or more data files, and selling application 116 may include instructions that, when executed by processing component 206 of remote server 104, unpack the one or more data files. Value estimation application 118 may include instructions that may then cause a value estimation to be performed on the images and description in the one or more data files. In some embodiments, the value estimation may be automatically performed using algorithms that are part of the instructions included in value estimation application. For example, the algorithms may analyze sales of similar items to determine an estimated value based on the images and description. In some embodiments, value estimation application 118 may include instructions for providing the images and description to one or more expert or trained estimators that may view the images, listen to and/or read the description, and estimate the value of the items.

Once the value of the items has been estimated, selling application 116 of remote server 104 may include instructions that, when executed, cause the estimated value to be sent to client computing device 102 over network 106. Selling application 112 of client computing device 102 may include instructions that may then cause interface 500 including the estimated value to be displayed. In some embodiments, processing component 206 may render interface 500 for display by display component 210.

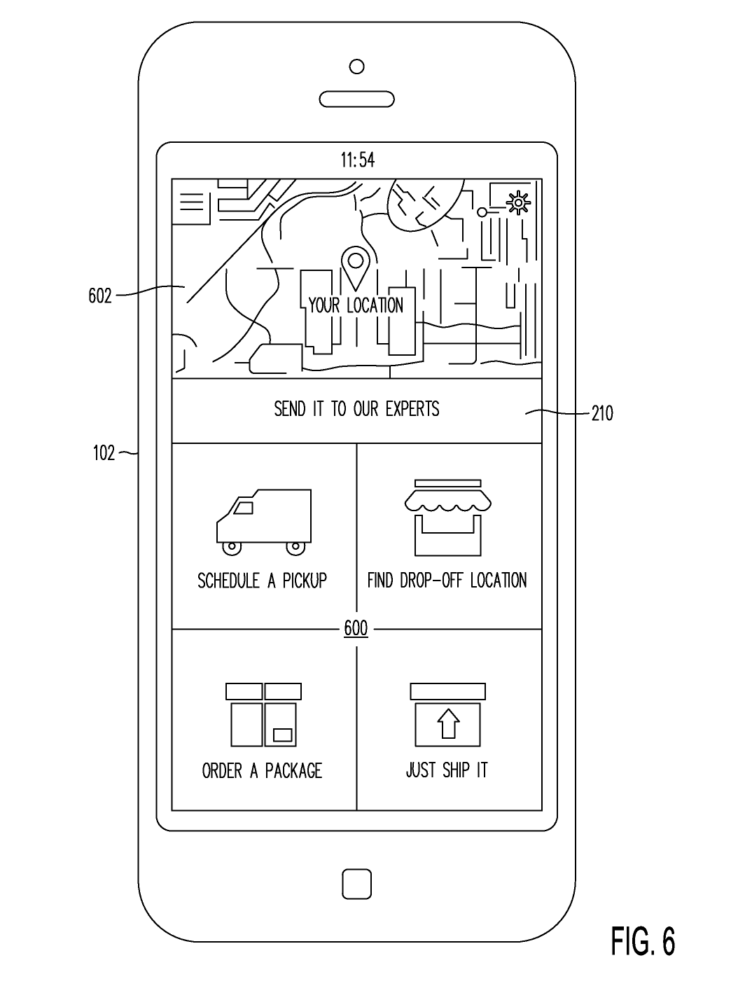

As shown in FIG. 5, interface 500 may include an area where user 108 may make a selection as to whether or not the estimated value is acceptable. If user 108 selects “YES”, selling application 112 may determine that user 108 wants to sell the item or items and proceed to display an interface 600 for selecting selling options, which is shown in FIG. 6, and discussed below. If user 108 selects “NO”, selling application 112 may determine that user 108 does not want to sell the item and may terminate or, in some embodiments, ask user 108 if they want another estimate, or even ask user 108 to provide additional information about the item to consider in making the value estimate.

FIG. 6 illustrates an interface 600 for selecting selling options, consistent with some embodiments. As shown in FIG. 6, selling application 112 may provide interface 600 to be displayed on display component 210 of client computing device 102 for user 108 to review selling options when user 108 decides to sell the item or items. In some embodiments, processing component 206 may render interface 600 for display by display component 210 based on instructions included in selling application 112. Interface 600 may allow user 108 to select from selling options such as scheduling a pickup, finding a drop-off location, ordering a pre-labeled package to fit the items for sale, or shipping the items without a pre-labeled package.

As shown in FIG. 6, interface 600 may include a map 602 that may show a location of user 108. In some embodiments, the location of user 108 may be determined by location component 216 of client computing device 102. In some embodiments, when user 108 selects the option to find a drop-off location map 602 may display locations nearby where user 108 may drop off the item or items. In such embodiments, selling application 112 may send a location of user 108 as obtained by location component 216 of client computing device 102 to remote server 104. Remote server 104 may then determine drop-off locations nearby the location of user 108 and send those locations back to client computing device 102 over network 106 for display in map 602. Alternatively, known drop-off locations may be stored in memory component 208 as part of selling application such that processing component 206 of client computing device may be able to determine and render for display nearby drop-off locations based on a determined location of user 108.

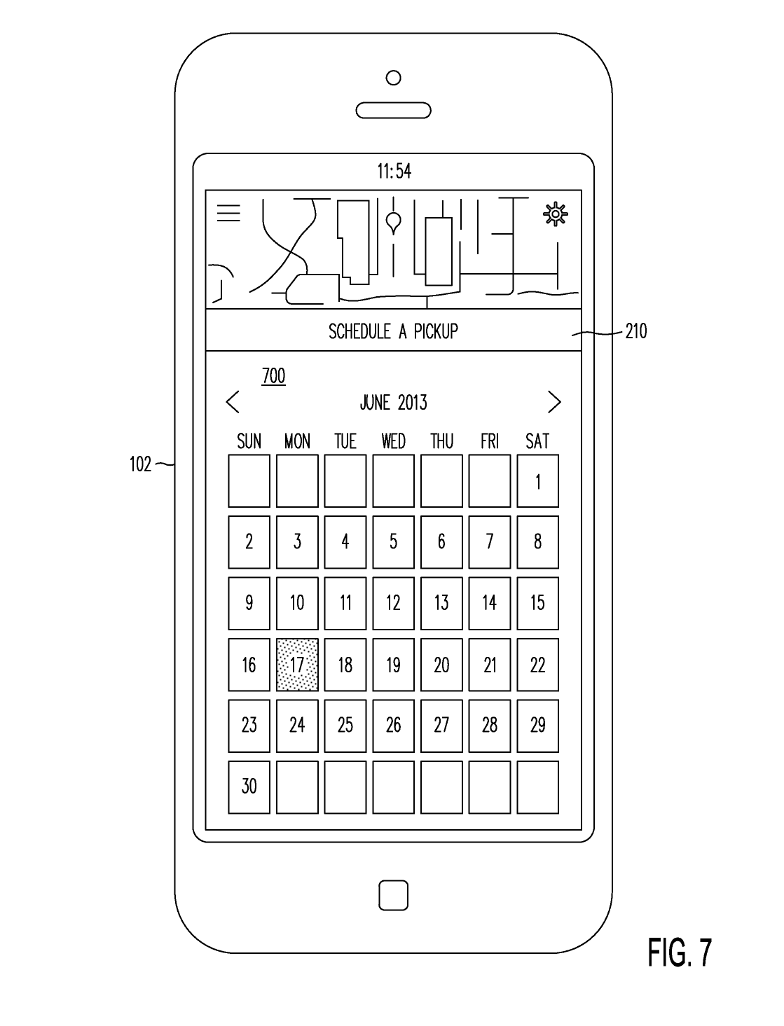

In some embodiments, when user 108 selects an option to schedule a pickup, selling application 112 may include instructions that, when executed by processing component 206 may cause processing component 206 to render an interface 700 for scheduling a pickup, as is shown in FIG. 7, and discussed below. When user 108 selects an option to order a package, selling application 112 may send a request to remote server 104 to order the package, and remote server 104 may respond with a request that user 108 provide an address or select an address from addresses saved in account information 122 of account database 120 associated with an account of user 108. Client computing device 102 may display the request, allow user 108 to make a selection or provide an address, and then send the response back to remote server 104 over network 106. Selling application 116 of remote server 104 may include instructions that may then, when executed by processing component 206 of remote server 106, automatically determine the proper sizes, dimensions, and labeling needed for enclosing the items user 108 is selling. The sizes and dimensions may be determined by the images and description provided by user 108. A pre-labeled package having the appropriate sizes and dimensions may then be sent to the address provided or selected by user 108.

FIG. 7 illustrates interface 700 for scheduling a pickup, consistent with some embodiments. As shown in FIG. 7, selling application 112 may provide interface 700 to be displayed on display component 210 of client computing device 102 for user 108 to select a date for home pickup of the items for sale. Interface 700 may allow user 108 to select a date for pickup using a calendar, and may show dates when pickup is available and may show dates when pickup is unavailable. In some embodiments, when user 108 selects the option to schedule a pickup a request may be sent to remote server 104, which may then respond with available dates and times. Selling application 112 may include instructions that may then cause interface 700 to be displayed on display component 210 of client computing device 102 displaying the available dates and times. When user 108 selects a date from interface 700, the selected date and time may be sent to remote server 104, and the pickup may be scheduled. In some embodiments, a user calendar in client computing device 102 part of other applications 114 or part of an operating system of client computing device 102 may be updated with the scheduled pick up date, such as by an appointment or reminder.

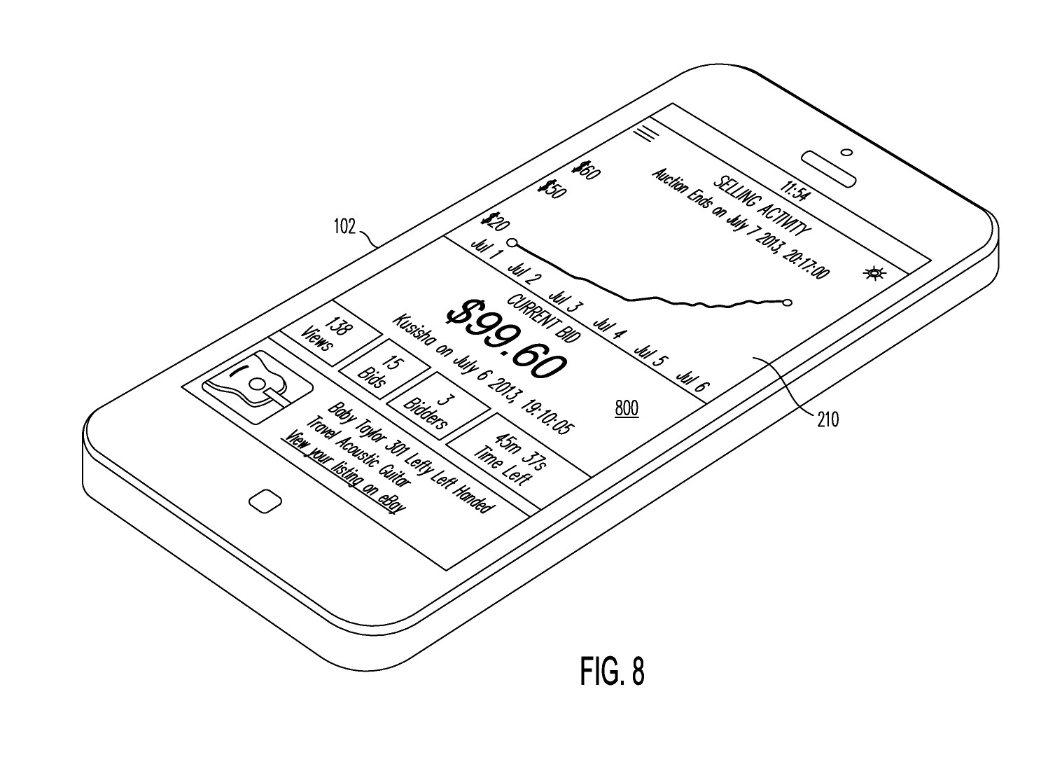

FIG. 8 illustrates an interface 800 for reviewing selling activity, consistent with some embodiments. As shown in FIG. 8, selling application 112 may provide interface 800 to be displayed on display component 210 of client computing device 102 for user 108 to view the selling activity associated with the items that user 108 is selling. Interface 800 may allow user 108 to review the current bid, the number of bids, the time left, and a graph illustrating the bid history over time. Other information may be shown in interface 800 in other embodiments. Selling application 112 may request and receive information from remote server 104 over network 106 to obtain information for display in interface 800.

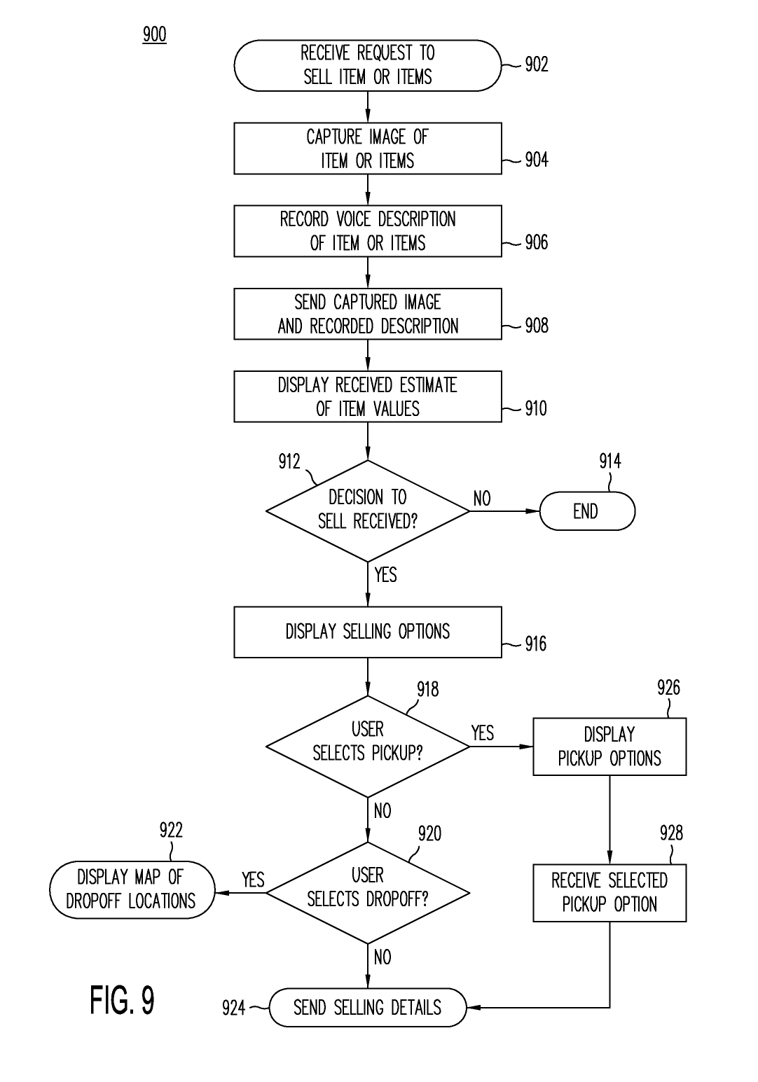

FIG. 9 is a flowchart illustrating a process 900 for selling one or more items using selling application 112. For the purpose of illustration, FIG. 9 may be described with reference to any of FIGS. 1-8. Process 900 shown in FIG. 9 may be embodied in computer-readable instructions for execution by one or more processors such that the steps of process 900 may be performed by processing component 206 of client computing device 102. In some embodiments, selling application 112 of client computing device 102 may include instructions for performing one or more steps of process 900. As shown in FIG. 9, process 900 may be initiated when user 108 activates, initiates, or otherwise causes selling application 112 to be executed, and user enters a request to sell one or more items (902). User 108 may then be presented with interface 300, and selling application 112 may use imaging component 218 of client computing device 102 to capture images of the item or items for sale (904). Selling application 112 may then present user 108 with interface 400 and user 108 may record a voice description of the item or items for sale (906). In some embodiments, user 108 may be able to provide a written description along with or instead of a voice description. User 108 may be able to enter a written or text description using input component 212 of client computing device 102.

Selling application 112 may then send the captured images and recorded description to remote server 104 (908). Selling application 116 of remote server 104 may receive the descriptions and provide the descriptions to value estimation 118 which may estimate the value of the item or items and provide the estimated value to client computing device 102 over network 106. Client computing device 102 may receive the estimated value and display the received estimated value (910) in an interface, such as interface 500, displayed on display component 210 of client computing device 102. When user 108 does not decide (912) to sell, process 900 may end (914). However, when user 108 decides (912) to sell, selling application 112 may display selling options (916) in an interface, such as interface 600. User 108 may be able to select one or more selling options from interface 600, such as pickup (918) or drop-off (920). When user 108 selects drop-off, selling application 112 may display a map 602 of drop-off locations (922). In some embodiments, selling application 112 may send a location of user 108 as obtained by location component 216 of client computing device 102 to remote server 104. Remote server 104 may then determine drop-off locations nearby the location of user 108 and send those locations back to client computing device 102 over network 106 for display in map 602. Alternatively, known drop-off locations may be stored in memory component 208 as part of selling application such that processing component 206 of client computing device may be able to determine and render for display nearby drop-off locations based on a determined location of user 108.

When user 108 does not select pickup or drop-off, such as selecting shipping or to receive a package, selling application 112 may send details of the item or items for sale to remote server 104 (920). When user 108 selects pickup, user may be presented with pickup options (926), such as a calendar displaying dates for pickup, such as shown in interface 700. Selling application 112 may receive a selected pickup option (928) from user 108 and provide the selected option along with other item details to remote server (924).

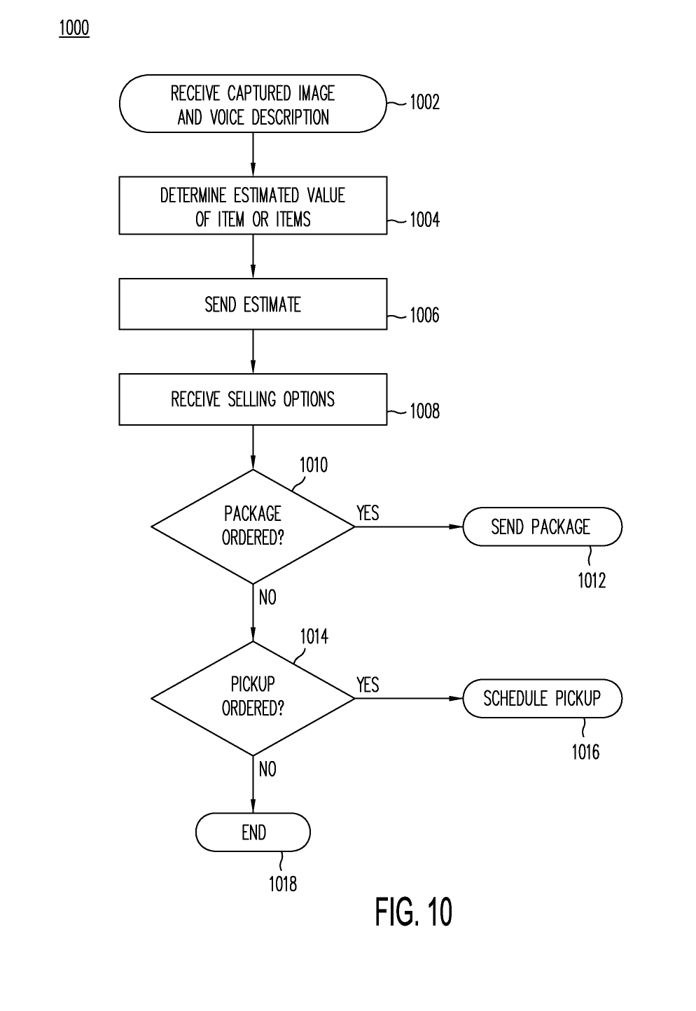

FIG. 10 is a flowchart illustrating a process 1000 for assisting user 108 in selling one or more items. For the purpose of illustration, FIG. 10 may be described with reference to any of FIGS. 1-8. Process 1000 shown in FIG. 10 may be embodied in computer-readable instructions for execution by one or more processors such that the steps of process 1000 may be performed by processing component 206 of remote server 104. In some embodiments, selling application 116 and value estimation 118 of remote server 104 may include instructions for performing one or more steps of process 1000. As shown in FIG. 10, process 1000 may be initiated when selling application 116 receives captured images and a voice description of an item or items for sale over network 106 from selling application 112 of client computing device 102 (1002). Based on the received captured images and voice description, an estimated value of the item or items may be determined (1004) and sent to client computing device 102 (1006) over network. In some embodiments, the estimated value of the item or items may be determined automatically using an algorithm. In other embodiments, the estimated value of the item or items may be determined by one or more experts reviewing the received captured images and voice description.

Selling options may then be received (1008). When a pre-labeled package is ordered for selling (1010), selling application 116 of remote server 104 may ensure that a properly sized, pre-labeled package is sent to user 108 based on the images and description previously received (1012). When a pickup is ordered (1014), selling application 116 of remote server 104 may send available dates to user 108 and then receive a preferred date or dates and times for pickup from user 108 and schedule the pickup (1016). In some embodiments, scheduling the pickup may include ensuring that a designated pickup entity is scheduled to pick up the item or items from user 108. If no package is ordered or pickup ordered, user 108 may have selected alternative options not necessarily handled by remote server 104 and process 1000 may end (1018).

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments consistent with this disclosure may provide a would-be seller with an estimated value of items for sale along with options for scheduling a pickup of the items, ordering a pre-labeled package for the items, or finding a drop-off location for the items to make the selling process much easier for the seller. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system for selling one or more items, comprising:
an imaging component configured to capture one or more images of the items;
a microphone configured to detect a voice description of the items and produce and electric signal corresponding to the detected voice description;
a memory configured to store the captured one or more images and the electric signal;
a network interface component configured to send the captured one or more images and the recoded voice description to a server for processing;
one or more processors configured to process the estimated value of the items when received from the server and render the estimated value of the items for display and render selling options when a user decides to sell the items;
a display component configured to display the rendered estimated value of the items and the rendered selling options when a user decides to sell the items; and
a bus coupling the imaging component, the microphone, the memory, the network interface component and the one or more processors.

2. The system of claim 1, wherein the one or more processors are further configured to process the electric signal and convert the electric signal into a text description.

3. The system of claim 1, wherein the one or more processors are further configured to render for display by the display component the selling options including options to schedule a pickup of the items, a drop-off of the items and request a pre-labeled package for the items.

4. The system of claim 3, wherein the one or more processors are further configured to:
determine when the user selects the option to schedule a pickup of the items;
determine available dates for pickup; and
render for display by the display component a calendar showing the determined available dates for pickup.

5. The system of claim 4, wherein the one or more processors are configured to determine available dates for pickup by generating a request for transmission by the network interface component to the server for available dates and processing a response from the server including the available dates.

6. The system of claim 3, further comprising a location component configured to determine a location of the system, wherein the one or more processors are further configured to render a map displaying nearby drop-off locations when the user selects the option to drop off the items using the determined location.

7. The system of claim 3, wherein the one or more processors are configured to render the map by generating a request for transmission by the network interface component to the server for locations near the determined location and processing a response form the server including the nearby locations.

8. A computer-readable medium including instructions that, when executed by one or more processors, cause the one or more processors to perform a method for selling one or more items, the method comprising:
capturing one or more images of the items;
recording a voice description of the items;
sending the captured one or more images and the recorded voice description;
receiving and displaying an estimated value of the items, the estimated value based on an analysis of the captured one or more images and the recorded voice description; and
displaying selling options when a user decides to sell the items.

9. The computer-readable medium of claim 8, wherein recording a voice description of the items comprises recording the voice description and converting the voice description to a text description.

10. The computer-readable medium of claim 8, wherein displaying selling options comprises displaying options to schedule a pickup of the items, select a drop-off of the items, and request a pre-labeled package for the items.

11. The computer-readable medium of claim 10, further comprising displaying a calendar of available dates for pickup when the user selects the option to schedule a pickup.

12. The computer-readable medium of claim 10, further comprising displaying a map of nearby drop-off locations when the user selects the option to drop off the items.

13. A computer-readable medium including instructions that, when executed by one or more processors, cause the one or more processors to perform a method for assisting a user in selling one or more items, the method comprising:
receiving at least one or more captured images and a voice description of the items;
determining an estimated value of the items;
sending the estimated value;
receiving selling options;
sending a pre-labeled package to the user when a package order selling option is received; and
scheduling a pickup of the items when a pickup selling option is received.

14. The computer-readable medium of claim 13, wherein determining an estimated value of the items comprises performing one or more algorithms on the received captured images and voice description.

15. The computer-readable medium of claim 13, wherein determining an estimated value of the items comprises performing an expert analysis on the received captured images and voice description.

16. The computer-readable medium of claim 13, wherein scheduling a pickup of the items comprises:
determining dates and times available for a pickup to be performed;
sending the determined dates and times to the user;
receiving a user selection of a pickup date and time; and
scheduling the pick at the selected pickup date and time.

17. The computer-readable medium of claim 13, further comprising:
receiving a user location when a drop-off selling option is selected;
determining drop-off locations nearby the user location; and
sending the determined drop-off locations to the user.

18. The computer-readable medium of claim 13, wherein sending a pre-labeled package to the user comprises:
determining one or more addresses of the user from a user account;
sending a request for a selection of one of the one or more addressed;
receiving the selection; and
sending the pre-labeled package to the selected address.

19. The computer-readable medium of claim 13, wherein sending a pre-labeled package to the user comprises:
determining dimensions of the items; and
sending the pre-labeled package to the user, wherein the pre-labeled package has dimensions sufficient to enclose the items.

20. The computer-readable medium of claim 13, further comprising:
listing the items on an online auction site.
